(19) United States
(12) Patent Application Publication
(10) Pub. No.: US 2020/0189645 A1
(43) Pub. Date: Jun. 18, 2020

(54) STEERING COLUMN DEVICE

(71) Applicant: FUJI KIKO CO., LTD., Kosai-shi (JP)

(72) Inventor: Osamu FUJIMURA, Kosai-shi (JP)

(21) Appl. No.: 16/715,646

(22) Filed: Dec. 16, 2019

(30) Foreign Application Priority Data
Dec. 18, 2018 (JP) 2018-236376

(51) Int. Cl. B62D 1/184; B62D 1/185

(52) U.S. Cl. CPC B62D 1/184; F16B 2/185; B62D 1/185

(57) ABSTRACT

An inner column is adjustable (movable) relative to an outer column in a vehicle body front-rear direction. Multiple wire insertion holes are provided in a wire locking member attached to a lower portion of the inner column. Inserting a wire insertion portion of the wire member into one of the wire insertion holes from each of the left and right sides restricts movement of the inner column relative to the outer column and the locked mechanism is set to a locked state. Operating an operation lever to turn a turning shaft turns and moves a cam portion on an outer peripheral portion of the turning shaft integrally with the operation lever. In this case, left and right tilted surfaces of the cam portion expands the wire member to the left and right and causes the wire insertion portions to disengage from the wire insertion holes to unlock the lock mechanism.

### CROSS REFERENCE TO RELATED APPLICATION

The present application is based on, and claims priority from Japanese Patent Application No. 2018-236376, filed Dec. 18, 2018, the disclosure of which is hereby incorporated by reference herein in its entirety.

### TECHNICAL FIELD

The present invention relates to a steering column device in which a steering column is movable and adjustable in a front-rear direction.

### BACKGROUND ART

A steering column device in which a steering column is configured to be movable in the front-rear direction is known (see Japanese Patent Application Publication No. 2013-256193). In the steering column device, a column jacket supporting a steering shaft is arranged between left and right side plates which hang down from an attachment bracket on the vehicle body side. The column jacket includes an inner tube and an outer tube and left and right side plates of a bracket for a telescopic mechanism fixed to the outer tube hold and fix the column jacket therebetween to restrict movement of the inner tube relative to the outer tube in the front-rear direction. In this case, multiple friction plates are stacked and arranged outside the side plates of the bracket and holding force is obtained by fastening the side plates and the multiple friction plates with a lock mechanism.

### SUMMARY

Since the lock mechanism of the steering column device includes the multiple friction plates, the number of parts increases and assembly work is complex.

Accordingly, an object of the present invention is to suppress an increase in the number of parts and simplify assembly work in a lock mechanism of a steering column device.

The steering column device of the present invention includes: a first member provided on a vehicle body side; a second member configured to be movable relative to the first member in a vehicle body front-rear direction and provided with a steering member; a shaft portion extending in a vehicle width direction and turnably provided on the first member; an operation portion allowing a turning operation of the shaft portion; a wire member which has an end portion on a vehicle body front side held by the first member and a rear end portion connected to the second member in front of the shaft portion with an intermediate portion of the wire member wound around an outer peripheral surface of the shaft portion; a plurality of wire insertion holes provided in the second member to be arranged in the vehicle body front-rear direction and configured to restrict movement of the second member relative to the first member in the front-rear direction by receiving the rear end portion of the wire member in the vehicle width direction; and a cam portion provided on the shaft portion and configured to elastically deform the wire member outward in the vehicle width direction and disengage the rear end portion of the wire member from the wire insertion hole when the shaft portion is turned by an operation on the operation portion.

According to the present invention, it is possible to suppress an increase in the number of parts and simplify assembly work in a lock mechanism of a steering column device.

### BRIEF DESCRIPTION OF DRAWINGS

FIG. 1 is a side view of a steering column device according to an embodiment of the present invention as viewed from the vehicle left side, the side view partially including a cross-sectional view.

FIG. 2 is a cross-sectional view illustrating a lock mechanism in the steering column device of FIG. 1.

FIG. 3A is a view as viewed in the direction of the arrow A in FIG. 2.

FIG. 3B is an operation explanation view illustrating a state where the lock mechanism is unlocked with respect to FIG. 3A.

FIG. 4 is a bottom view of FIG. 2.

FIG. 5 is a perspective view in which an outer column illustrated in FIG. 2 is turned up-side down.

FIG. 6A is a perspective view illustrating a wire member used in the lock mechanism together with a turning shaft.

FIG. 6B is an operation explanation view illustrating a change in the shape of the wire member in the state where the lock mechanism is unlocked with respect to FIG. 6A.

FIG. 7 is a perspective view illustrating a wire locking member used in the lock mechanism together with an inner column.

FIG. 8A is a perspective view illustrating a state where the wire member is locked to the wire locking member.

FIG. 8B is an operation explanation view illustrating a state where the wire member is disengaged from the wire locking member and the lock mechanism is unlocked with respect to FIG. 8A.

FIG. 9 is an operation explanation view illustrating a state where the inner column moves forward relative to the outer column in secondary collision from the state of FIG. 2.

FIG. 10 is a bottom view of FIG. 9.

FIG. 11 is an operation explanation view illustrating a state where a stopper member is disengaged from the outer column in the secondary collision with respect to FIG. 5.

### DESCRIPTION OF EMBODIMENTS

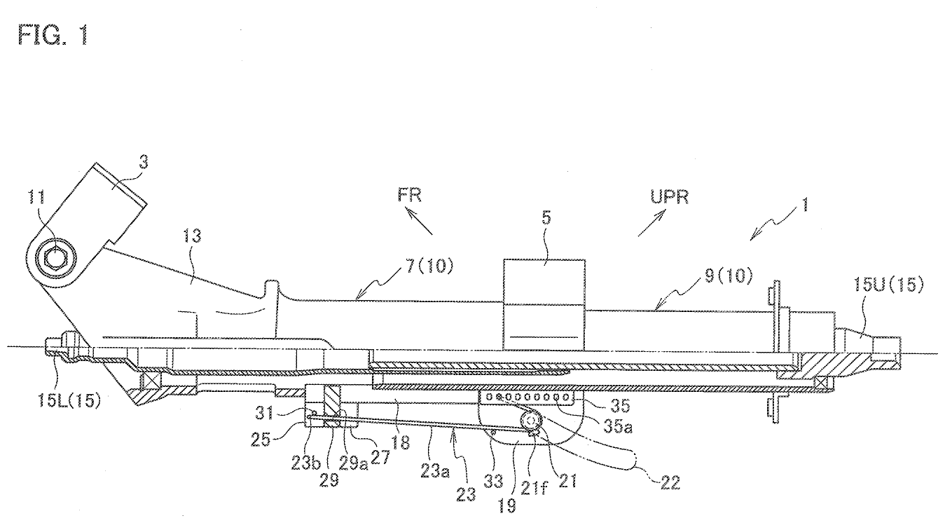

An embodiment of the present invention is described below based on the drawings. Note that “front-rear direction” in the following description corresponds to a front-rear direction of a vehicle and a “left-right direction” corresponds to a left-right direction (vehicle width direction) of the vehicle. In FIG. 1, the front side in the “front-rear direction” is indicated by the arrow FR and the vehicle upper side is indicated by the arrow UPR.

As depicted in FIG. 1, a steering column device 1 according to the embodiment is a manual type. The steering column device 1 includes a front attachment bracket 3 and a center attachment bracket 5 which are fixed to a vehicle body. An outer column 7 which is a first member is supported on the front attachment bracket 3 and the center attachment bracket 5 to be swingable in a vehicle up-down direction. An inner column 9 which is a second member is supported on the outer column 7. A tilt mechanism in which the outer column 7 and the inner column 9 swing in the vehicle up-down direction is thereby formed.

The outer column 7 is arranged on the vehicle front side, the inner column 9 is arranged on the vehicle rear side of the outer column 7, and the inner column 9 is inserted on the inner peripheral side of the outer column 7. The outer column 7 and the inner column 9 form a steering column 10. The front attachment bracket 3 includes a pivotal support portion 11 configured to support the outer column 7 such that the outer column 7 can swing about an axis.

The outer column 7 has a tubular shape and is arranged to extend in the vehicle front-rear direction and the vehicle up-down direction. The outer column 7 includes a pivotal support reception portion 13 in a front end section. The pivotal support reception portion 13 is pivotally supported on the pivotal support portion 11 of the front attachment bracket 3 and the outer column 7 and the inner column 9 thereby swing in the vehicle up-down direction about the turning center of the pivotal support portion 11. The inner column 9 has a tubular shape and is inserted in the tube of the outer column 7 to be movable in an axial direction.

A steering shaft 15 is pivotally supported in the tubes of the inner column 9 and the outer column 7. The steering shaft 15 is formed of a lower shaft 15L pivotally supported inside the outer column 7 and an upper shaft 15U pivotally supported inside the inner column 9. The upper shaft 15U and the lower shaft 15L are connected to each other by splines and are thereby configured such that the upper shaft 15U and the lower shaft 15L rotate integrally about an axis and the upper shaft 15U is movable relative to the lower shaft 15L in the axial direction. A telescopic mechanism which holds the upper shaft 15U (inner column 9) in a manner movable relative to the lower shaft 15L (outer column 7) in the vehicle front-rear direction is thus formed. A steering wheel is attached to a rear end of the upper shaft 15U as a not-illustrated steering member.

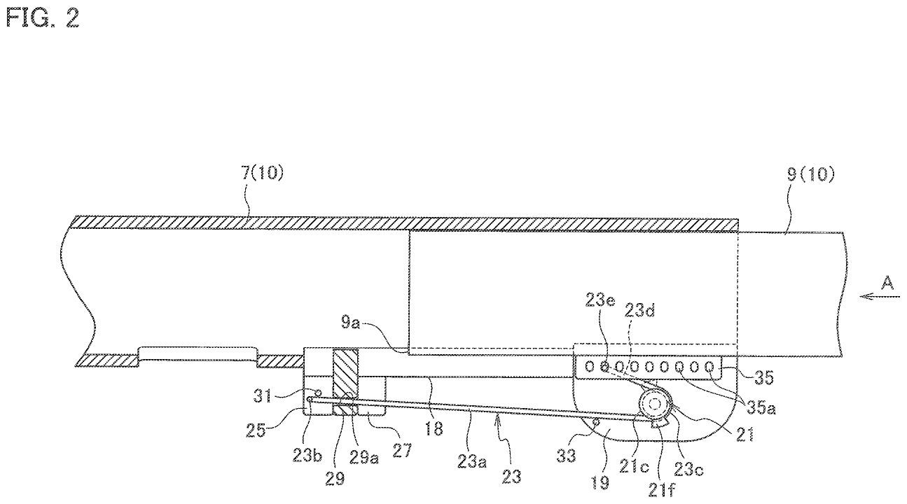

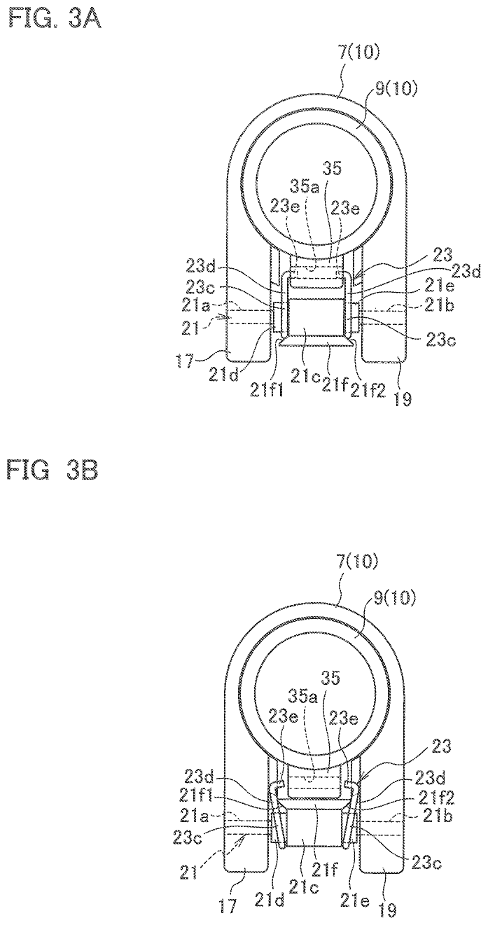

FIG. 2 illustrates a configuration which allows the inner column 9 of FIG. 1 to move relative to the outer column 7 in the vehicle front-rear direction in an enlarged manner. Note that the upper shaft 15U and the lower shaft 15L are omitted in FIG. 2. As illustrated in FIGS. 2 and 3A, paired left and right side walls 17, 19 extending downward from both sides of the outer column 7 in the vehicle width direction are formed in a rear lower portion of the outer column 7.

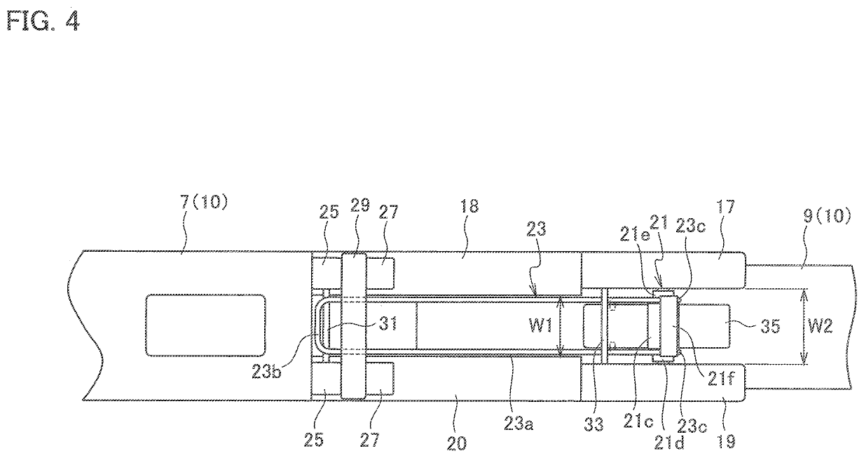

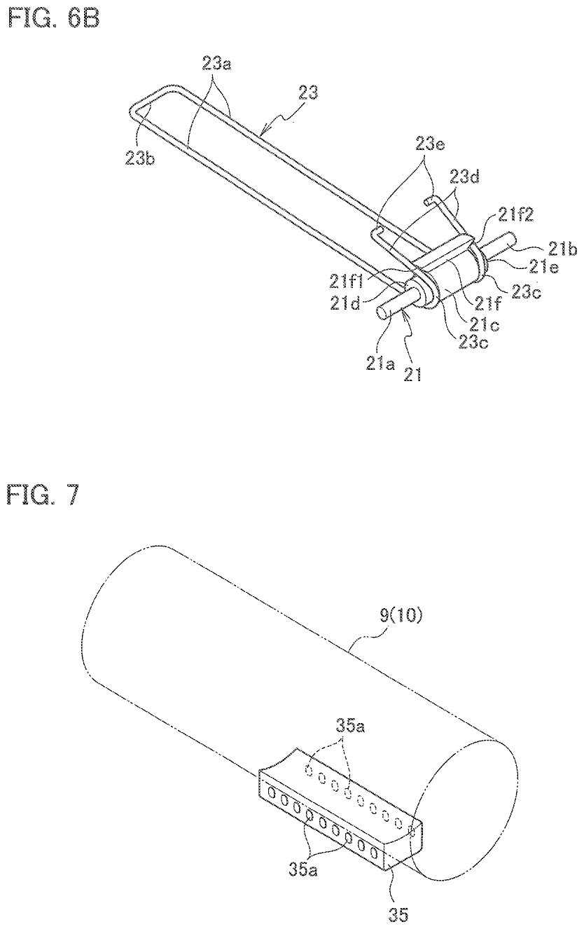

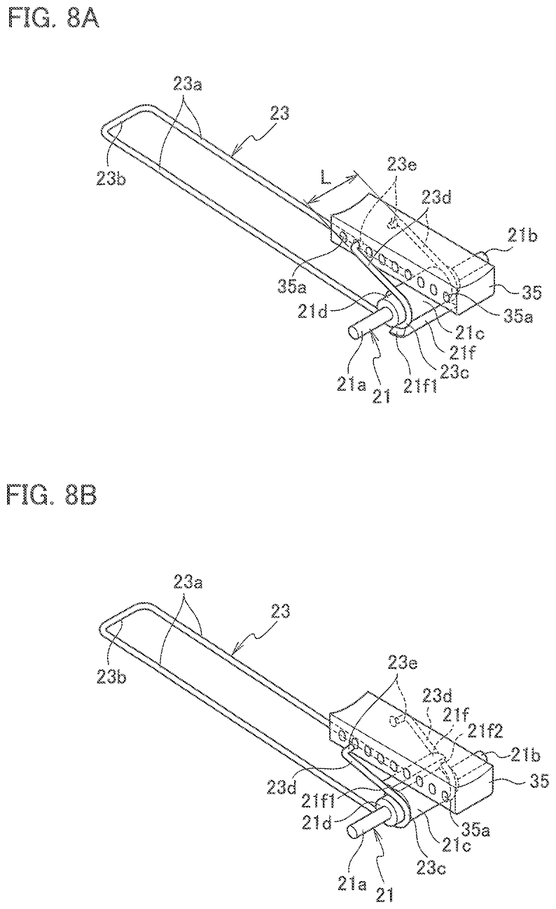

As illustrated in FIGS. 2, 4, and 5, paired left and right guide walls 18, 20 protrude downward in front of the side walls 17, 19 in the lower portion of the outer column 7. The guide walls 18, 20 extend in the front-rear direction parallel to the side walls 17, 19. As illustrated in FIG. 4, an interval W1 between the guide walls 18, 20 is smaller than an interval W2 between the side walls 17, 19 (W1<W2). As illustrated in FIGS. 6A and 8A, the interval W1 between the guide walls 18, 20 is substantially equal to or slightly larger than the width of a wire member 23 to be described later, particularly the width L between bent back portions 23d in the vehicle width direction in a state where wire insertion portions 23e of the wire member 23 are inserted in wire insertion holes 35a (W1≥L). In this case, portions of the paired left and right guide walls 18, 20 facing each other are close to or in contact with outer sides of the wire member 23 (bent back portions 23d) in the vehicle width direction.

A turning shaft 21 which is a shaft portion extending in the vehicle width direction is supported on the side walls 17, 19 to be turnable (rotatable) about an axis. An operation lever 22 which is an operation portion for operating and turning the turning shaft 21 is attached to an end portion of the turning shaft 21 in the axial direction. As illustrated in FIGS. 3A and 6A, the turning shaft 21 includes turning support portions 21a, 21b supported on the side walls 17, 19 and a large-diameter portion 21c located at the center in the axial direction between the turning support portions 21a, 21b and having a larger diameter than the turning support portions 21a, 21b. Wire winding portions 21d, 21e having a diameter larger than the turning support portions 21a, 21b and smaller than the large-diameter portion 21c are formed between the turning support portion 21a and the large-diameter portion 21c and between the turning support portion 21b and the large-diameter portion 21c.

A cam portion 21f is formed in an outer peripheral portion of the large-diameter portion 21c. The large-diameter portion 21c, the wire winding portions 21d, 21e, and the cam portion 21f are located between the side walls 17, 19. As illustrated in FIG. 2, in the attached state, the cam portion 21f is located at a position slightly shifted to the rear side from a position just below the large-diameter portion 21c in the vertical direction. As illustrated in FIG. 3A, the cam portion 21f includes tilted surfaces 21f1, 21f2 in outer end portions in the vehicle width direction. The tilted surfaces 21f1, 21f2 are each tilted outward in the vehicle width direction while extending from an outer periphery of an axial direction end portion of the large-diameter portion 21c toward the outer side in the diametric direction of the large-diameter portion 21c and form pressing portions.

The wire member 23 is wound around the wire winding portions 21d, 21e. As illustrated in FIGS. 4 and 6A, the wire member 23 is formed by bending a metal wire material and has a substantially U shape in a plan view. The wire member 23 includes paired left and right extending portions 23a extending in the vehicle front-rear direction and front end portions of the extending portions 23a are connected to each other by a connection portion 23b extending in the vehicle width direction.

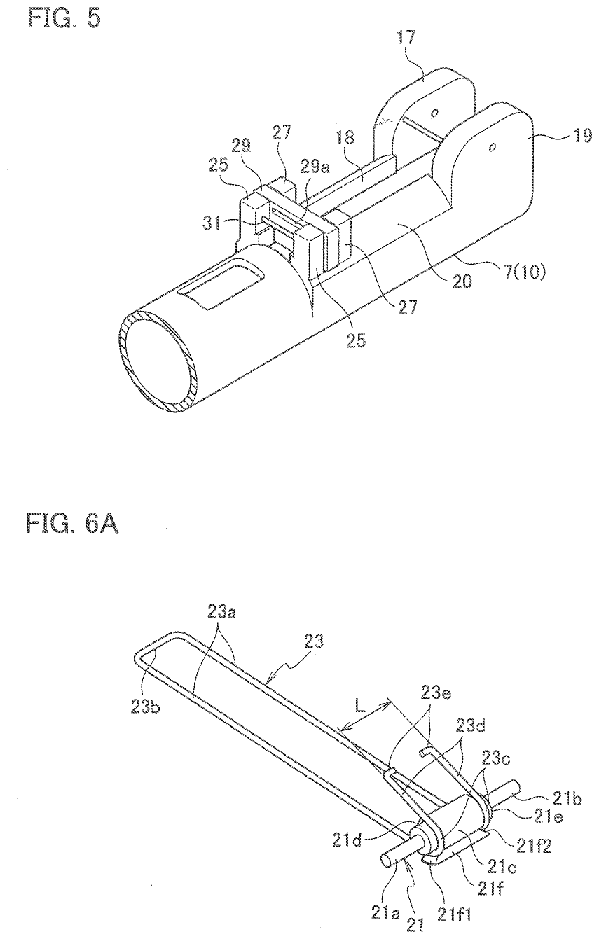

As illustrated in FIGS. 2 and 4, first protruding pieces 25 and second protruding pieces 27 protrude downward near a position corresponding to the connection portion 23b in the lower portion of the outer column 7. The first protruding pieces 25 are provided in front of the second protruding pieces 27 at intervals. As illustrated in FIGS. 4 and 5, the paired first protruding pieces 25 and the paired second protruding pieces 27 are provided on the left and right sides of the wire member 23. Note that, in FIG. 5, parts are turned up-side down from those in FIG. 2.

A stopper member 29 with a cuboid shape elongating in the vehicle width direction is arranged between the first protruding pieces 25 and the second protruding pieces 27. When the inner column 9 is adjusted to the foremost position, a front end 9a of a lower portion of the inner column 9 comes into contact with the stopper member 29 and the stopper member 29 thereby restricts the forward movement. Note that the stopper member 29 is movable relative to the first protruding pieces 25 and the second protruding pieces 27 in the up-down direction.

A slit 29a into which the extending portions 23a of the wire member 23 are inserted is formed in the stopper member 29. As illustrated in FIG. 5, the slit 29a is a long hole elongating in the vehicle width direction and penetrates the stopper member 29 in the front-rear direction. A front holding pin 31 extending in the vehicle width direction is attached to the paired left and right first protruding pieces 25.

In the state where the wire member 23 is inserted in the slit 29a, portions of the extending portions 23a in front of the slit 29a elastically come into contact with the front holding pin 31 from below. The connection portion 23b is located slightly in front of the front holding pin 31. Portions of the extending portions 23a near and behind the stopper member 29 are located between the paired left and right second protruding pieces 27. The wire member 23 is in contact with the front holding pin 31 from below in the state inserted in the slit 29a and this causes portions near the connection portion 23b in front of the extending portions 23a to serve as a hold portion held by the outer column 7. In other words, the extending portions 23a extend from the hold portion near the connection portion 23b toward the vehicle rear side.

Portions of the wire member 23 behind the extending portions 23a are curved portions 23c wound around the wire winding portions 21d, 21e of the turning shaft 21. As illustrated in FIGS. 2 and 4, a rear holding pin 33 extending in the vehicle width direction is provided in front of and below the turning shaft 21 between the side walls 17, 19. The rear holding pin 33 is located slightly below the front holding pin 31 and the extending portions 23a elastically come into contact with the rear holding pin 33 from above.

Since the wire member 23 has characteristics of a spring, the front portion (upper portion) thereof presses the front holding pin 31 upward while the rear portion (lower portion) thereof presses the rear holding pin 33 downward. The paired left and right curved portions 23c are in contact with outer side surfaces of the large-diameter portion 21c in the axial direction while being wound around the wire winding portions 21d, 21e.

The wire member 23 includes the paired left and right bent back portions 23d continuous with the curved portions 23c on the opposite side to the extending portions 23a. The bent back portions 23d extend from the curved portions 23c toward the upper front side. The paired left and right wire insertion portions 23e which are insertions portions are formed continuously with end portions of the bent back portions 23d on the opposite side to the curved portions 23c. The paired left and right wire insertion portions 23e extend toward each other and front end portions thereof are spaced away from each other.

As illustrated in FIG. 2, a wire locking member 35 is attached to a lower portion of an outer periphery of the inner column 9. As illustrated in FIG. 7, the wire locking member 35 has a substantially cuboid shape elongated in the front-rear direction and slightly elongated in the left-right direction. An upper surface of the wire locking member 35 has a concave arc-shape corresponding to a circular shape of the outer peripheral surface of the inner column 9 and is integrally fixed to the outer peripheral surface of the inner column 9 to be in close contact therewith.

Multiple wire insertion holes 35a are provided on left and right surfaces of the wire locking member 35 to be arranged in the front-rear direction. As illustrated in FIG. 8A, the paired left and right wire insertion portions 23e of the wire member 23 are inserted respectively into one of the multiple left wire insertion holes 35a arranged in the front-rear direction and one of the multiple right wire insertion holes 35a arranged in the front-rear direction. In the wire member 23, portions around the paired bent back portions 23d press the wire locking member 35 from left and right sides to hold the wire locking member 35 therebetween (between the paired bent back portions 23d) in the state where the wire insertion portions 23e are inserted in the wire insertion holes 35a.

The state where the wire insertion portions 23e are inserted in the wire insertion holes 35a can be thereby more surely maintained and the inner column 9 can be more surely locked and fixed to the outer column 7 at the adjusted position in the front-rear direction.

When the position of the inner column 9 relative to the outer column 7 in the front-rear direction is to be adjusted, the operation lever 22 illustrated in FIG. 1 is operated and turned to turn the turning shaft 21. When the turning shaft 21 turns counterclockwise in FIG. 2 from the state illustrated in FIGS. 2, 3A, 6A, and 8A, the cam portion 21f located on the lower right side of the turning shaft 21 in FIG. 2 turns and moves in the same direction integrally with the turning shaft 21 and is set to the state illustrated in FIGS. 3B, 6B, and 8B.

The clockwise turning and moving of the cam portion 21f in FIG. 2 causes the curved portions 23c and the bent back portions 23d to be elastically deformed and gradually pushed away from one another toward the outer sides in the axial direction by the tilted surfaces 21f1, 21f2 of the cam portion 21f. In this case, the curved portions 23c gradually move away from the outer side surfaces of the large-diameter portion 21c in the axial direction, from the state in contact therewith.

Pushing the bent back portions 23d away from each other toward the outer sides in the left-right direction causes the wire insertion portions 23e at the front ends to also move toward the outer sides in the left-right direction. As a result, the wire insertion portions 23e disengage from the wire insertion holes 35a. A locked state between the wire insertion portions 23e and the wire insertion holes 35a is thus released and an unlocked state is established. In the unlocked state, the inner column 9 is movable relative to the outer column 7 in the front-rear direction and the position of the inner column 9 in the front-rear direction can be adjusted.

After the position adjustment of the inner column 9 in the front-rear direction, the operation lever 22 is operated and turned in the opposite direction to that in the aforementioned operation. This causes the turning shaft 21 to turn clockwise in FIG. 2 and the cam portion 21f returns to the position of FIGS. 2, 3A, 6A, and 8A. The wire insertion portions 23e are thereby inserted into the wire insertion holes 35a and the locked state is established.

In this case, there may be a situation where the wire insertion portions 23e are not inserted into the wire insertion holes 35a and come into contact with portions of the wire locking member 35 between the wire insertion holes 35a. However, since the paired left and right wire insertion portions 23e are constantly elastically pressed in the direction coming close to each other, the wire insertion portions 23e can easily inserted into the wire insertion holes 35a by slightly moving the inner column 9 in the front-rear direction.

Next, description is given of a function where, in secondary collision occurring in vehicle collision, the inner column 9 is moved forward relative to the outer column 7 by impact load to absorb impact energy.

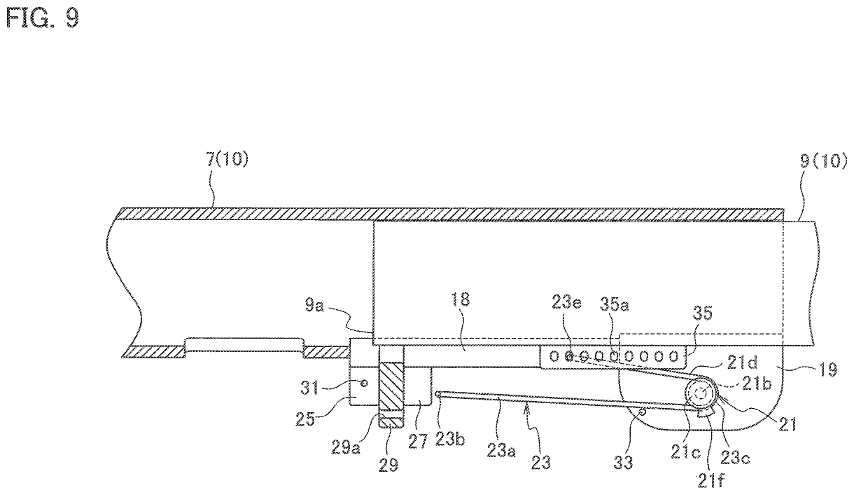

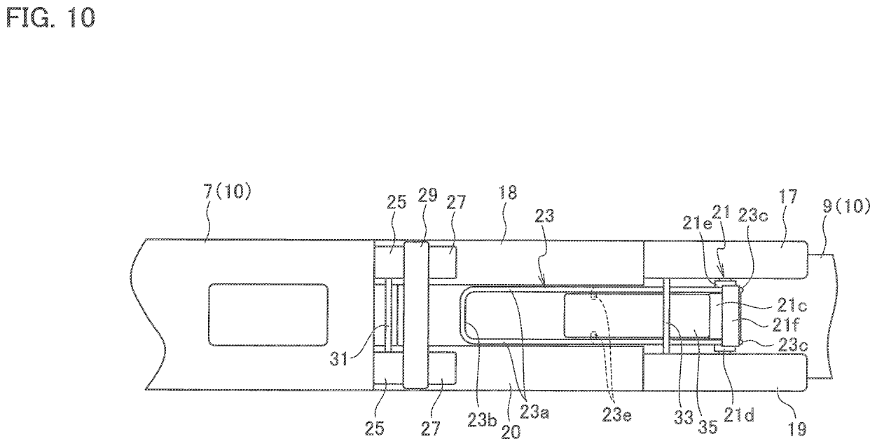

When the inner column 9 receives forward impact load in the state where the lock mechanism of FIG. 2 is locked, the inner column 9 moves forward relative to the outer column 7. In this case, since the wire insertion portions 23e are inserted in the wire insertion holes 35a and locked, the wire member 23 receives load in a direction in which the wire insertion portions 23e are pulled forward by the inner column 9. In this case, the wire member 23 deforms from the state of FIGS. 2 and 4 to the state of FIGS. 9 and 10 while being stoked such that the portions (curved portion 23c) wound around the wire winding portions 21d, 21e of the turning shaft 21 gradually come close to the connection portion 23b with the extending portion 23a supported by the rear holding pin 33 from below.

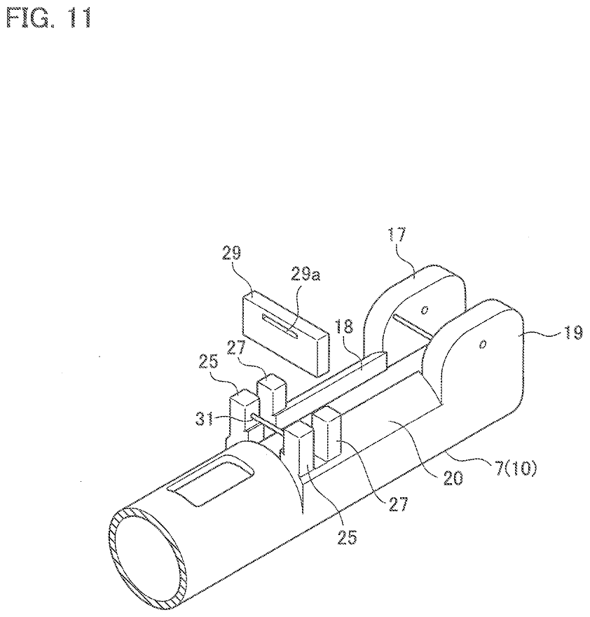

In this case, the connection portion 23b in the front portion of the wire member 23 moves away from the front holding pin 31 and disengages from the slit 29a. The stopper member 29 thereby moves downward and falls and the inner column 9 is allowed to move forward beyond the position where the stopper member 29 is arranged. The impact absorbing performance is thus improved. FIG. 11 is a view in which the parts are up-side down like FIG. 5 and illustrates a state where the stopper member 29 is disengaged from the outer column 7.

When the inner column 9 receives the impact load and moves forward relative to the outer column 7, as illustrated in FIG. 10, the wire locking member 35 enters the space between the guide walls 18, 20. In this case, the wire insertion portions 23e and the bent back portions 23d of the wire member 23 also enter the space between the guide walls 18, 20. In this case, the surfaces of the paired left and right guide walls 18, 20 facing each other are close to or in contact with the outer sides of the wire member 23 (bent back portions 23d) in the vehicle width direction. Accordingly, portions of the wire member 23 around the wire insertion portions 23e and the bent back portions 23d entering the space between the guide walls 18, 20 are substantially in contact with the inner surfaces of the guide walls 18, 20 facing each other and are pressed by the inner surfaces from the left and right sides.

Accordingly, in the course of the inner column 9 receiving the impact load and moving forward relative to the outer column 7, the guide walls 18, 20 can suppress the disengagement of the wire insertion portions 23e from the wire insertion holes 35a. In this case, since the inner column 9 moves forward with the wire insertion portions 23e inserted in the wire insertion holes 35a, the stroking deformation of the wire member 23 is continuously performed and the impact absorbing function is thus continuously exhibited.

Next, operations and effects of the embodiment are described.

The steering column device 1 of the embodiment includes: the outer column 7 provided on the vehicle body side; the inner column 9 configured to be movable relative to the outer column 7 in the vehicle body front-rear direction and provided with the steering wheel; the turning shaft 21 extending in the vehicle width direction and turnably provided on the outer column 7; and the operation lever 22 allowing the turning operation of the turning shaft 21.

The steering column device 1 includes: the wire member 23 which has the vehicle body front side end portions held by the outer column 7 and the rear end portions connected to the inner column 9 in front of the turning shaft 21 with the curved portions 23c wound around the outer peripheral surface of the turning shaft 21, the curved portions 23c being the intermediate portions of the wire member 23; and the multiple wire insertion holes 35a provided in the inner column 9 to be arranged in the vehicle body front-rear direction and configured to restrict the movement of the inner column 9 relative to the outer column 7 in the front-rear direction by receiving the rear end portions of the wire member 23 in the vehicle width direction.

The steering column device 1 includes the cam portion 21f provided on the turning shaft 21 and configured elastically deform the wire member 23 outward in the vehicle width direction and disengage the wire insertion portions 23e in the rear end portions of the wire member 23 from the wire insertion holes 35a when the turning shaft 21 is turned by the operation on the operation lever 22.

In the steering column device 1 with the aforementioned configuration, the wire insertion portions 23e of the wire member 23 are inserted in the wire insertion holes 35a as the lock mechanism configured to restrict the movement of the inner column 9 relative to the outer column 7 in the front-rear direction. Accordingly, the number of parts is smaller than that in a configuration including multiple friction plates as the lock mechanism of the steering column device 1. Moreover, since it is only necessary to attach the wire member 23, the attachment work is simpler than that in the case where the multiple friction plates are attached.

The wire member 23 of the embodiment includes: the hold portion (front portions of the extending portions 23a) held by the outer column 7; the paired left and right extending portions 23a extending from the hold portion toward the vehicle body rear side; the paired left and right curved portions 23c continuous with rear portions of the paired extending portions 23a and wound around the turning shaft 21 while being arranged outside the cam portion 21f in the vehicle width direction; the paired left and right bent back portions 23d continuous with the paired curved portions 23c on the opposite side to the extending portions 23a and extending toward the vehicle body front side; and the paired left and right insertion portions 23e extending from the front ends of the paired bent back portions 23d toward each other and configured to be inserted into the wire insertion holes 35a.

As described above, since the wire member 23 is formed by bending one wire member, the wire member 23 can be easily manufactured and contribute to cost reduction.

The cam portion 21f of the embodiment includes the paired left and right tilted surfaces 21f1, 21f2 configured to push the paired left and right bent back portions 23d of the wire member 23 away from each other by turning and moving integrally with the turning shaft 21 from the state where the wire insertion portions 23e of the wire member 23 are inserted in the wire insertion holes 35a.

In this case, the turning and moving of the cam portion 21f with the turning of the turning shaft 21 causes the tilted surfaces 21f1, 21f2 to push the paired bent back portions 23d to the left and right, away from each other. Accordingly, the wire insertion portions 23e can be easily disengaged from the wire insertion holes 35a and the unlocking work is facilitated.

The paired left and right tilted surfaces 21f1, 21f2 of the embodiment are tilted away from each other while extending from the outer peripheral surface of the turning shaft 21 toward the outer side in the diametric direction. Accordingly, in the turning and moving of the cam portion 21f with the turning of the turning shaft 21, the tilted surfaces 21f1, 21f2 gradually expand the wire member 23 and the wire insertion portions 23e are smoothly disengaged from the wire insertion holes 35a.

The outer column 7 of the embodiment is provided with the paired left and right guide walls 18, 20 extending downward, on the vehicle body front side of the wire insertion holes 35a and outside the wire member 23 in the vehicle width direction. The portions of the paired left and right guide walls 18, 20 facing each other are close to or in contact with the outer sides of the wire member 23 in the vehicle width direction as viewed in the vehicle body front-rear direction.

Accordingly, in the course of the inner column 9 receiving the impact load and moving forward relative to the outer column 7, the guide walls 18, 20 support the wire member 23 from the left and fight sides and can suppress the disengagement of the wire insertion portions 23e from the wire insertion holes 35a.

Although the embodiment of the present invention has been described above, the embodiment is merely an example described to facilitate the understanding of the present invention and the present invention is not limited to the embodiment. The technical scope of the present invention is not limited to the specific technical matters disclosed in the aforementioned embodiment but includes various modifications, changes, alternative techniques, and the like which can be easily derived therefrom.

What is claimed is:

1. A steering column device comprising:
a first member provided on a vehicle body side;
a second member configured to be movable relative to the first member in a vehicle body front-rear direction and provided with a steering member;
a shaft portion extending in a vehicle width direction and turnably provided on the first member;
an operation portion allowing a turning operation of the shaft portion;
a wire member which has an end portion on a vehicle body front side held by the first member and a rear end portion connected to the second member in front of the shaft portion with an intermediate portion of the wire member wound around an outer peripheral surface of the shaft portion;
a plurality of wire insertion holes provided in the second member to be arranged in the vehicle body front-rear direction and configured to restrict movement of the second member relative to the first member in the front-rear direction by receiving the rear end portion of the wire member in the vehicle width direction; and
a cam portion provided on the shaft portion and configured to elastically deform the wire member outward in the vehicle width direction and disengage the rear end portion of the wire member from the wire insertion hole when the shaft portion is turned by an operation on the operation portion.

2. The steering column device according to claim 1, wherein the wire member includes:
a hold portion held by the first member;
paired left and right extending portions extending from the hold portion toward a vehicle body rear side;
paired left and right curved portions continuous with rear portions of the paired left and right extending portions and wound around the shaft portion while being arranged outside the cam portion in the vehicle width direction;
paired left and right bent back portions continuous with the paired left and right curved portions on the opposite side to the extending portions and extending toward the vehicle body front side; and
paired left and right insertion portions extending from front ends of the paired left and right bent back portions toward each other and configured to be inserted into the wire insertion holes.

3. The steering column device according to claim 1, wherein the cam portion includes paired left and right pressing portions configured to push paired left and right bent back portions of the wire member away from each other by turning and moving integrally with the shaft portion from a state where insertion portions of the wire member are inserted in the wire insertion holes.

4. The steering column device according to claim 3, wherein the paired left and right pressing portions are tilted away from each other while extending from the outer peripheral surface of the shaft portion toward the outer side in a diametric direction.

5. The steering column device according to any one of claim 1, wherein
the first member is provided with a guide wall extending downward, on the vehicle body front side of the wire insertion holes and outside the wire member in the vehicle width direction, and
the guide wall is close to or in contact with an outer side of the wire member in the vehicle width direction as viewed in the vehicle body front-rear direction.
